(19) United States
(12) Patent Application Publication
(10) Pub. No.: US 2025/0026652 A1
(43) Pub. Date: Jan. 23, 2025

(54) APPARATUS AND METHOD FOR PRODUCTION OF GREEN AMMONIA USING HEAT EXCHANGER UNIT

(71) Applicant: ACWA POWER Company, Riyadh (SA)

(72) Inventor: Venkata Krishna VAKACHARLA, Dubai (AE)

(73) Assignee: ACWA POWER Company, Riyadh (SA)

(21) Appl. No.: 18/757,334

(22) Filed: Jun. 27, 2024

Related U.S. Application Data
(60) Provisional application No. 63/514,759, filed on Jul. 20, 2023.

(51) Int. Cl. C01C 1/04; C25B 1/04; C25B 15/02; C25B 15/08

(52) U.S. Cl. CPC C01C 1/0482; C25B 1/04; C25B 15/02; C25B 15/081

(57) ABSTRACT

An apparatus and method for production of green ammonia using a heat exchanger unit controls a compressor unit to increase a first pressure value of a first set of reactants to a second pressure value, and a set of heat exchanger units to increase temperature of a second set of reactants to a second temperature value using heat generated during production of green ammonia in the reactor. The apparatus also controls a reactor unit to produce green ammonia at a first timestamp and at a second timestamp based upon a chemical reaction between the reactants of the corresponding first and second set of reactants. The second set of reactants are fed into the reactor unit at the second pressure value and a third temperature value. The apparatus also controls a storage unit to store green ammonia produced at the first and second timestamps.

### CROSS-REFERENCE TO RELATED APPLICATIONS

This application claims priority to U.S. Provisional Patent Application Ser. No. 63/514,759, filed Jul. 20, 2023, and entitled “APPARATUS AND METHOD FOR PRODUCTION OF GREEN AMMONIA USING HEAT EXCHANGER UNIT”, the disclosure of which is incorporated herein by reference.

### TECHNOLOGICAL FIELD

The present disclosure generally relates to production of green ammonia, more particularly relates to apparatus and method for production of green ammonia using heat exchanger unit.

### BACKGROUND

Green ammonia refers to ammonia that is produced using renewable energy sources instead of conventional fossil fuels. Traditional ammonia production process relies on Haber-Bosch process which combines nitrogen from the air with hydrogen typically derived from natural gas, resulting in carbon dioxide emissions. In contrast, the green ammonia production aims to eliminate these emissions by utilizing hydrogen produced through water electrolysis powered by renewable energy sources like wind solar or hydropower. In such a process, water splits into hydrogen and oxygen using electricity from renewable sources ensuring that the hydrogen used in the ammonia synthesis is carbon free.

The production of green ammonia involved integrating renewable energy with advanced electrolyzer to generate hydrogen in a sustainable manner. The hydrogen is then fed into Haber-Bosch process to synthesize ammonia but without the associated carbon footprint of traditional methods. By leveraging renewable energy, green ammonia can serve as a clean fuel, carbon-neutral fertilizer, and a crucial component in reducing greenhouse gas emission across various industries.

However, the chemical reaction in the Haber-Bosch process to synthesize ammonia requires an enormous amount of heat to produce green ammonia. Further, such high energy consumption of the green ammonia production plant increases the overall expense for the production of green ammonia which is a vital chemical that has various applications. Therefore, there is need for optimizing the process for production of the green ammonia.

### BRIEF SUMMARY

The present invention discloses an apparatus and a method for production of green ammonia using the heat exchanger unit, thereby optimizing the process to produce the green ammonia.

In one aspect, an apparatus for production of green ammonia using heat exchanger unit is provided. The apparatus may include one or more processors. The processor may be configured to control compressor unit to compress a first set of reactants to increase a pressure of the first set of reactants from a first pressure value to a second pressure value. The processor may be further configured to control a reactor unit to produce green ammonia at a first timestamp based on a chemical reaction between the compressed first set of reactants. The processor may be further configured to control a set of heat exchanger units to increase a temperature of a second set of reactants from a first temperature value to a second temperature value using heat generated during the production of the green ammonia in the reactor unit at the first timestamp. The processor may be further configured to control the reactor unit to produce the green ammonia at a second timestamp based on the chemical reaction between the second set of reactants. The second set of reactants may be fed into the reactor unit at the second pressure value and at a third temperature value. Further, the processor may be configured to control a storage unit to store the green ammonia produced at the first timestamp and the second timestamp.

In one embodiment, the first set of reactants and the second set of reactants may include hydrogen and nitrogen.

In one embodiment, the third temperature value may be greater than the second temperature value.

In one embodiment, the third temperature value may be same as the second temperature value.

In one embodiment, the apparatus may further include a hydrogen generation unit. The processor may be further configured to execute the computer-executable instructions to control the hydrogen generation unit to produce hydrogen by electrolyzing water. The first set of reactants and the second set of reactants may include the produced hydrogen.

In another embodiment, the apparatus may further include a hydrogen storage unit. The processor may be further configured to execute the computer-executable instructions to control the hydrogen storage unit to store the produced hydrogen.

In one embodiment, the apparatus may further include an air separation unit. The processor may be further configured to execute the computer-executable instructions to control the air separation unit to produce nitrogen. The first set of reactants and the second set of reactants may include the produced nitrogen.

In one embodiment, the first temperature value may be 85 degrees Celsius, the second temperature value may be 150 degrees Celsius, and the third temperature value may lie between a range of 330 degrees Celsius to 500 degrees Celsius.

In one embodiment, the second pressure value may lie between a range of 140 bars to 250 bars, and the first pressure value may be less than the second pressure value.

In one embodiment, the first set of reactants may be compressed by the compressor unit using at least one of a reciprocating compressor unit, a centrifugal compressor unit, or an axial flow compressor unit.

In one embodiment, the reactor unit may utilize an iron-based catalyst to facilitate at least one of the chemical reactions between the compressed first set of reactants, and the chemical reaction between the second set of reactants.

In one embodiment, the apparatus may further include a chilling unit. The processor may be further configured to execute the computer-executable instructions to control the chilling unit to decrease a temperature of the green ammonia produced at the first timestamp and the second timestamp from the third temperature value to a fourth temperature value. The third temperature value may be greater than the fourth temperature value.

In one embodiment, the temperature of the green ammonia may be decreased by the chilling unit using at least one of a chiller and refrigeration compressor.

In one embodiment, the processor may be further configured to execute the computer-executable instructions to control the chilling unit using to compress the produced green ammonia in the storage unit.

In other aspect, a method for production of green ammonia using heat exchanger unit is provided. The method may include controlling a compressor unit to compress a first set of reactants to increase a pressure of the first set of reactants from a first pressure value to a second pressure value. The method may further include controlling a reactor unit to produce green ammonia at a first timestamp based on a chemical reaction between the compressed first set of reactants. The method may further include controlling a set of heat exchanger units to increase a temperature of a second set of reactants from a first temperature value to a second temperature value using heat generated during the production of the green ammonia in the reactor unit. The method may further include controlling the reactor unit to produce the green ammonia at a second timestamp based on the chemical reaction between the second set of reactants. The second sets of reactants are fed into the reactor unit at the second pressure value and at a third temperature value. Further, the method may include controlling a storage unit to store the green ammonia produced at the first timestamp and the second timestamp.

In one method embodiment, the first set of reactants and the second set of reactants may include hydrogen and nitrogen.

In one method embodiment, the method may include controlling a hydrogen generation unit to produce hydrogen by electrolyzing water. The first set of reactants and the second set of reactants may include the produced hydrogen.

In another method embodiment, the first temperature value is 85 degrees Celsius, the second temperature value is 150 degrees Celsius, and the third temperature value lies between 330 degrees Celsius to 500 degrees Celsius.

In one method embodiment, the method may include controlling an air separation unit to produce nitrogen. The first set of reactants and the second set of reactants may include the produced nitrogen.

In yet another aspect, a non-transitory computer-readable medium having stored thereon, computer-executable instructions that when executed by a processor of a system, cause the processor to execute operations, the operations include controlling a compressor unit to compress a first set of reactants to increase a pressure of the first set of reactants from a first pressure value to a second pressure value. The operations may further include controlling a reactor unit to produce green ammonia at a first timestamp based on a chemical reaction between the compressed first set of reactants. The operations may further include controlling a set of heat exchanger units to increase a temperature of a second set of reactants from a first temperature value to a second temperature value using heat generated during the production of the green ammonia in the reactor unit. The operations may further include controlling the reactor unit to produce the green ammonia at a second timestamp based on the chemical reaction between the second set of reactants. The second sets of reactants are fed into the reactor unit at the second pressure value and at a third temperature value. Further, the operations may include controlling a storage unit to store the green ammonia produced at the first timestamp and the second timestamp.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 is a diagram that illustrates a network environment in which an apparatus production of green ammonia using heat exchanger unit is implemented, in accordance with an embodiment of the disclosure;

FIG. 2 illustrates a block diagram of the apparatus of FIG. 1, in accordance with an embodiment of the disclosure;

FIG. 3 is an exemplary schematic diagram of the apparatus for production of green ammonia using heat exchanger unit, in accordance with an embodiment of the present disclosure; and

FIG. 4 is a flowchart that illustrates an exemplary method for production of green ammonia using heat exchanger unit, in accordance with an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

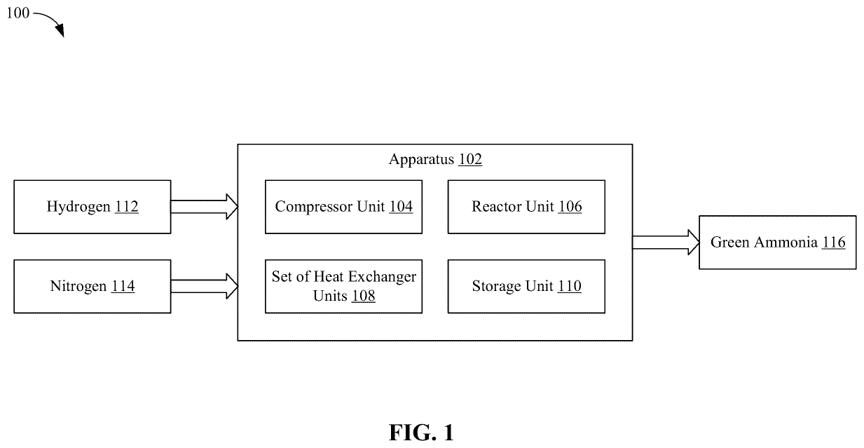

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 4, a brief description concerning the various components of the present disclosure will now be briefly discussed. Reference will be made to the figures showing various embodiments of an apparatus for production of green ammonia using heat exchangers.

FIG. 1 is a diagram that illustrates a network environment in which an apparatus production of green ammonia using heat exchanger unit is implemented, in accordance with an embodiment of the disclosure. With reference to FIG. 1, there is shown a network environment 100. The network environment 100 may include an apparatus 102 which may be used for production of green ammonia. The apparatus 102 may include a compressor unit 104, a reactor unit 106, a set of heat exchanger units 108, and a storage unit 110. The network environment 100 may further include hydrogen 112, nitrogen 114, and green ammonia 116.

The apparatus 102 may be designed to perform operations for production of the green ammonia 116. Specifically, the apparatus 102 focuses on heat recovery as well as heat utilization in a process to produce green ammonia 116. The apparatus 102 may employ a series of operations on the nitrogen 114 and the hydrogen 112 to produce the green ammonia 116. In an embodiment, the apparatus 102 may be configured to control the compressor unit 104 to compress a first set of reactants (for example, the hydrogen 112, and the nitrogen 114) to increase a pressure of the first set of reactants from a first pressure value to a second pressure value. The apparatus 102 may be further configured to control the reactor unit 106 to produce the green ammonia 116 at a first timestamp based on a chemical reaction between the compressed first set of reactants. Further, the apparatus 102 may be configured to control the set of heat exchanger units 108 to increase a temperature of a second set of reactants (for example, the hydrogen 112, and the nitrogen 114) from a first temperature value to a second temperature value using heat generated during the production of the green ammonia 116 in the reactor unit 106 at the first timestamp. Thereafter, the apparatus 102 may be further configured to control the reactor unit 106 to produce the green ammonia 116 at a second timestamp based on the chemical reaction between the second set of reactants. The second set of reactants may be fed into the reactor unit 106 at the second pressure value and at a third temperature value. Further, the apparatus 102 may be configured to control the storage unit 110 to store the green ammonia 116 produced at the first timestamp and the second timestamp. Examples of the apparatus 102 to produce the green ammonia 116 may include, but is not limited to, an electrolyzer-based apparatus, and a Haber Bosch process-based apparatus. In one embodiment, a control system may be associated with the apparatus 102 and may perform the series of operations to produce the green ammonia 116.

The compressor unit 104 corresponds to a mechanical device designed to compress a gas, thereby increasing the pressure of the gas. Typically, the compressor unit 104 includes a compressor, an electric motor or an engine, a control system, a cooling system, and a filter. In an example, the compressor unit 104 may be driven by an electric motor or a fuel powered engine. Further, the compressor unit 104 compresses the gas using mechanisms like pistons, screws, or rotary blades. Additionally, the control system ensures efficient operation, and the cooling system removes excess heat generated during compression. Further, the filter cleans the gas by removing contaminants and moisture, thereby ensuring high quality output. The compressor unit 104 is essential in applications such as, but not limited to, gas transmission pipelines, refrigeration, air conditioning, and other industrial processes requiring high pressure gas. Examples of the compressor unit 104 may include, but are not limited to, a centrifugal compressor, a reciprocating compressor, an axial compressor, and a liquid ring compressor.

The set of heat exchanger units 108 corresponds to a device designed to efficiently transfer heat from one fluid (for example, liquid or gas) to another, without mixing the two fluids. This may enable transfer of thermal energy for heating or cooling purposes. The set of heat exchanger units 108 includes components for example, but not limited to, tubes, plates, or fins, which facilitates efficient thermal transfer. The two fluids flow through separate channels within the heat exchanger unit, thereby allowing the heat to pass through one fluid (such as a hot fluid) to another (such as a cold fluid). The set of heat exchanger units 108 may be essential for improving energy efficiency and maintaining optimal operating temperature in various systems. Further, the set of heat exchanger units 108 may be used in a variety of applications including, but are not limited to, chemical processing, heating, cooling, air conditioning systems, refrigeration, and power plants.

The storage unit 110 may correspond to a storage container specifically designed to store fluid, for example, liquid or gas. This may allow safe storage of the fluid, thereby preventing leaks or releases of the fluid. Specifically, the storage unit 110 may be designed to safely store the green ammonia 116. Examples of the storage unit 110 may include, but are not limited to, an ammonia storage tank, an ammonia refrigerated storage tank, and an ammonia transport container.

Typically, the green ammonia 116 may be a vital industry chemical and may serve as a precursor for the production of various products such as fertilizers, plastics, cleaning agents, and the like which aids the increasing demand for green ammonia 116. Traditionally, the green ammonia 116 may be produced based on a chemical reaction between the hydrogen 112 and the nitrogen 114 at an extremely high pressure (e.g., 140-250 bars) and an extremely high temperature (e.g., around 350 degrees Celsius) in the presence of a suitable catalyst. Usually, the green ammonia 116 may be produced at a large scale using the Haber-Bosch process. The Haber-Bosch process involves an exothermic reaction between the hydrogen 112 and the nitrogen 114 to produce the green ammonia 116. The chemical reaction in the Haber-Bosch process conducted in the reactor unit 106 requires an enormous amount of heat to produce the green ammonia 116. Further, such chemical reaction between nitrogen 114 and hydrogen 112 requires an ample amount of heat and an ample amount of pressure to facilitate an efficient production of the green ammonia 116.

To overcome the problem associated with the production of the green ammonia 116, the present disclosure provides the apparatus 102 for the production of green ammonia 116 efficiently and economically. The disclosed apparatus 102 may focus on heat recovery as well as heat utilization in a process for the production of green ammonia 116.

In operation, the apparatus 102 may control the compressor unit 104 to compress the first set of reactants to increase the pressure of the first set of reactants from a first pressure value to a second pressure value. The first set of reactants may include for example, but is not limited to, hydrogen 112 and nitrogen 114. Thereafter, the compressed first set of reactants may be transmitted to the set of heat exchanger units 108 to increase a temperature of the first set of reactants to a first temperature value. Further, the apparatus 102 may control the reactor unit 106 to produce the green ammonia 116 at a first timestamp based on a chemical reaction between the compressed first set of reactants. The reactor unit 106 may correspond to a mechanical device designed to produce the green ammonia 116 by employing the Haber-Bosch process. Further, the reactor unit 106 may include a high pressure and high temperature reactor vessel, thereby facilitating the synthesis reaction between the nitrogen 114 and the hydrogen 112 under high pressure and temperature in presence of a catalyst to produce the green ammonia 116. The catalyst used in the chemical reaction may maximize the conversion of the nitrogen 114 and the hydrogen 112 into the green ammonia 116, thereby ensuring a high yield of green ammonia 116. In an example, the catalyst may correspond to iron with promotor elements like potassium and aluminum oxide. By way of an example and not limitation, the reactor unit 106 maximizes the conversion of the nitrogen 114 and the hydrogen 112 into green ammonia 116, operating under high pressure of around 100-300 bar pressure, and a high temperature range between 300-500 degree Celsius. The reactor unit 106 may further include various system for feeding gases, removing heat generated by exothermic reaction, and separating and recycling unreacted gases.

Further, the apparatus 102 may control the reactor unit 106 to produce the green ammonia 116 at a second timestamp (after the first timestamp) based on the chemical reaction between the second set of reactants. The second set of reactants may be fed into the reactor unit 106 at the second pressure value and at a third temperature value. Thereafter, the apparatus 102 may control the storage unit 110 to store the green ammonia 116 produced at the first timestamp and the second timestamp. The storage unit 110 may facilitate safe handling and efficient storage of the green ammonia for various industrial and agricultural applications.

Typically, the production of green ammonia 116 may be facilitated at a temperature nearly equal to 350 degrees Celsius. While in operation, the apparatus 102 may control the set of heat exchanger units 108 to increase a temperature of the second set of reactants from the first temperature value to the second temperature value using heat generated during the production of the green ammonia 116 in the reactor unit 106 at the first timestamp. The second set of reactants may include hydrogen 112 and nitrogen 114. Thus, the apparatus 102 may utilize heat of the produced green ammonia 116 available at the said temperature in further production of green ammonia 116 by supplying this heat to the nitrogen 114 and hydrogen 112. This may save energy and enhance the production of green ammonia 116 through a heat recovery and utilization mechanism (for example, by using the set of heat exchanger units 108).

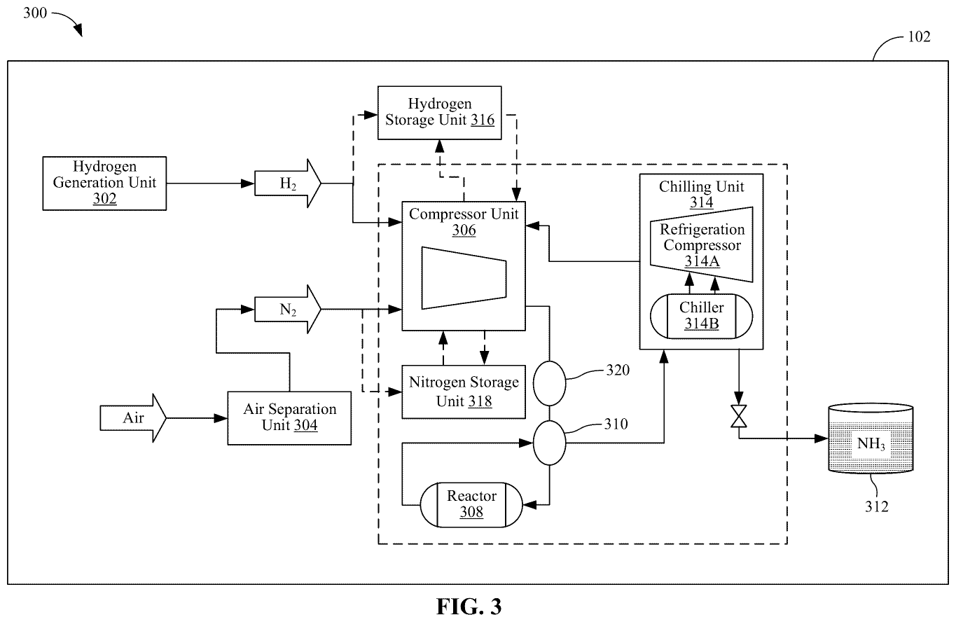

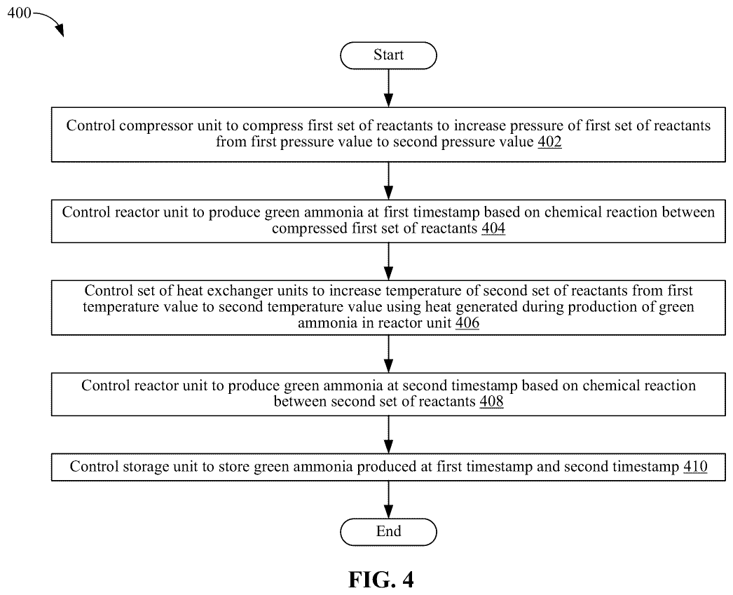

The functions or operations executed by the apparatus 102 are described in detail, for example, in FIG. 3, and FIG. 4.

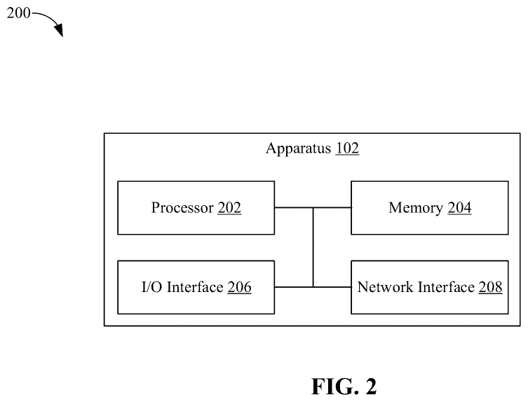

FIG. 2 illustrates a block diagram of the apparatus of FIG. 1, in accordance with an embodiment of the disclosure. FIG. 2 is explained in conjunction with FIG. 1. In FIG. 2, there is shown the block diagram 200 of the apparatus 102. The apparatus 102 may include at least one processor (referred to as a processor 202, hereinafter), at least one non-transitory memory (referred to as a memory 204, hereinafter), an input/output (I/O) interface 206, and a network interface 208. The processor 202 may be connected to the memory 204, the I/O interface 206, and the network interface 208 through one or more wired or wireless connections. Although in FIG. 2, it is shown that the apparatus 102 includes the processor 202, the memory 204, the I/O interface 206, and the network interface 208 however, the disclosure may not be so limiting and the apparatus 102 may include fewer or more components to perform the same or other functions of the apparatus 102.

The processor 202 of the apparatus 102 may be configured to perform one or more operations associated with the production of the green ammonia 116 using the set of heat exchanger units 108. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The communication network may be accessed using the network interface 208 of the apparatus 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In some example embodiments, the I/O interface 206 may communicate with the apparatus 102 and display the input and/or output of the apparatus 102. As such, the I/O interface 206 may include a display device and, in some embodiments, may also include a keyboard, a mouse, a touch screen, touch areas, soft keys, or other input/output mechanisms. In one embodiment, the apparatus 102 may include a user interface circuitry configured to control at least some functions of one or more I/O interface elements such as a display and, in some embodiments, a plurality of speakers, a ringer, one or more microphones and/or the like. The processor 202 may be configured to control one or more functions of one or more I/O interface 206 elements through computer program instructions (for example, software and/or firmware) stored on the memory 204 accessible to the processor 202.

The network interface 208 may include the input interface and output interface for supporting communications to and from the apparatus 102 or any other component with which the apparatus 102 may communicate. The network interface 208 may be any means such as a device or circuitry embodied in either hardware or a combination of hardware and software that is configured to receive and/or transmit data to/from a communications device in communication with the apparatus 102. In this regard, the network interface 208 may include, for example, an antenna (or multiple antennae) and supporting hardware and/or software for enabling communications with a wireless communication network. Additionally, or alternatively, the network interface 208 may include the circuitry for interacting with the antenna(s) to cause transmission of signals via the antenna(s) or to handle receipt of signals received via the antenna(s). In some environments, the network interface 208 may alternatively or additionally support wired communication. As such, for example, the network interface 208 may include a communication modem and/or other hardware and/or software for supporting communication via cable, digital subscriber line (DSL), universal serial bus (USB), or other mechanisms.

FIG. 3 is an exemplary schematic diagram of the apparatus for production of green ammonia using heat exchanger unit, in accordance with an embodiment of the present disclosure. FIG. 3 is explained in conjunction with FIG. 1 and FIG. 2. With reference to FIG. 3, there is shown a schematic diagram 300 of the apparatus 102 for production of the green ammonia 116. The apparatus 102 may include a hydrogen generation unit 302, an air separation unit 304, a compressor unit 306, a reactor unit 308, a set of heat exchanger units 310, and the storage unit 312. The compressor unit 306, the reactor unit 308, the set of heat exchanger units 310, and the storage unit 312 may be exemplary implementation of the compressor unit 104, the reactor unit 106, the set of heat exchanger units 108, and the storage unit 110 of FIG. 1, respectively.

For production of the green ammonia 116, the apparatus 102 may receive the hydrogen 112 and the nitrogen 114. In an embodiment, the apparatus 102 may include the hydrogen generation unit 302 to produce the hydrogen 112, and the air separation unit 304 to produce the nitrogen 114.

In an embodiment, the processor 202 may be configured to control the hydrogen generation unit 302 to produce hydrogen 112 by electrolyzing water. Specifically, the hydrogen generation unit 302 may use electrolysis for the production of hydrogen 112 from renewable as well as nuclear resources. Electrolysis is a process that may use electricity to split water into hydrogen and oxygen at an electrolyzing temperature. The electrolyzing temperature may be the temperature at which a molecule of water (H₂O) may be broken into one hydrogen (H₂) molecule and one oxygen atom. For example, the electrolyzing temperature for the water is 85 degrees Celsius. In operation, the hydrogen generation unit 302 may receive water to produce the hydrogen 112, and an electric current may be passed through the water to initiate different reactions (e.g., an oxidation reaction and/or a reduction reaction) at different electrodes (e.g., an anode and/or a cathode) of the hydrogen generation unit 302. For example, at the anode, the oxidation reaction may take place the causing hydrogen generation unit 302 to produce oxygen. Further, at the cathode, the reduction reaction may take place causing the hydrogen generation unit 302 to produce hydrogen (H₂) in a gaseous form. The hydrogen 112 generated during electrolysis may be collected separately from the oxygen. Since hydrogen gas is lighter than the air, it can be collected by displacement or through a gas-collecting apparatus. The hydrogen generation unit 302 functions in different ways, mainly due to the different types of electrolyte material involved and the ionic species it conducts. Examples of hydrogen generation unit 302 may include, but are not limited to, a polymer electrolyte membrane hydrogen generation unit, an alkaline hydrogen generation unit, and a solid oxide hydrogen generation unit.

In an embodiment, the apparatus 102 may further include a hydrogen storage unit 316. The processor 202 may be further configured to control the hydrogen storage unit 316 to store the produced hydrogen 112. The storage of produced hydrogen 112 may require decreasing a temperature value of the produced hydrogen 112 to a suitable temperature required for the storage. In an example, the produced hydrogen 112 may be transferred to the compressor unit 104 for further process and excess hydrogen 112 may be stored in hydrogen storage unit 316.

In an embodiment, the processor 202 may be configured to control the air separation unit 304 to produce nitrogen 114 from the air. In an embodiment, the air separation unit 304 may be an apparatus or a device that may be used to separate air into its primary constituents, namely the nitrogen 114, oxygen, argon, and the like. The most common method for air separation may be fractional distillation performed in a cryogenic production of nitrogen 114. The air separation unit 304 may utilize a process known as cryogenic distillation to produce the nitrogen 114. The air separation unit 304 may use a multi-column cryogenic distillation process that leverages different boiling points of gases present in the air for achieving air separation more accurately. In example, the air separation unit 304 may use methods such as, but not limited to, a pressure swing adsorption (PSA) method, and a vacuum pressure swing adsorption (VPSA) method to separate the nitrogen 114 from the air. Typically, the air separation unit 304 involves several processing steps such as, but not limited to, air compression, purification, cryogenic cooling, and separation to produce nitrogen 114 from the air. Further, produced nitrogen 114 by the air separation unit 304 may be transferred to the compressor unit 104. In an example, the produced nitrogen 114 may be stored in a nitrogen storage unit 318.

Thereafter, the processor 202 may be configured to control the compressor unit 104 to compress a first set of reactants to increase a pressure of the first set of reactants from a first pressure value to a second pressure value. The first set of reactants may include the hydrogen 112 and the nitrogen 114. In an example, the produced hydrogen 112, and the produced nitrogen 114 may be directly transferred to the compressor unit 104 before cooling and storing in their respective storage units (for example, the hydrogen storage unit 316, and the nitrogen storage unit 318) to save energy in reheating the first set of reactants to suitable temperature, thereby making the first set of reactants suitable to be fed to the compressor unit 104.

In an example, the compressor unit 306 may elevate the pressure of the first set of reactants (the nitrogen 114 and the hydrogen 112) to the second pressure value to make the first set of reactants suitable for the production of green ammonia 116. The first pressure value may correspond to a pressure at which the first set of reactants may be fed into the compressor unit 306. The second pressure value may correspond to a pressure that may be required to conduct the chemical reaction for the production of green ammonia 116. In an example, the second pressure value may correspond to a numeric value that lies between a range from a lower range of 140 bars to a higher range of 250 bars. Further, the first pressure value may be less than the lower range of the second pressure value. For example, the first pressure value may correspond to a numeric value that lies between a range of 8-30 bars.

In an embodiment, the first set of reactants may be compressed by the compressor unit 104 using, but not limited to, a reciprocating compressor unit, a centrifugal compressor unit, and an axial flow compressor unit. The reciprocating compressor unit may be a type of positive displacement compressor. The reciprocating compressor unit may include a cylindrical chamber with piston. Further, the reciprocating compressor unit may use a piston movement (such as moving back and forth within the cylindrical chamber) towards a discharge valve to compress the first set of reactants. As the piston moves down it draws gas into the cylindrical chamber through an intake valve. On the contrary, as the piston moves up it compresses the gas and pushes it out through a discharge valve. The reciprocating compressor unit may be commonly used in applications requiring higher pressure and relatively low flow rates for example, but not limited to, refrigeration, air conditioning, natural gas processing, and other industrial processes.

The centrifugal compressor unit may be a dynamic compressor that increases the pressure of the set of reactants by using a high-speed rotating impeller to impart kinetic energy to the first set of reactants, which may be then converted to pressure energy in a diffuser. In operation, the first set of reactants may enter the centrifugal compressor unit near the axis of rotation and may be accelerated radially outward by the impeller, thereby resulting in a rise in pressure and velocity. The centrifugal compressor unit may be suited for applications requiring large volumes of gas at moderate pressures for example, but not limited to, gas turbines, and chemical processing.

The axial compressor unit may be a type of dynamic compressor where the gas flows parallel to the axis of rotation through a series of rotating and stationary blades known as rotor and stator blades. The set of reactants may be progressively compressed as it passes through each stage, increasing its pressure and velocity. The axial compressor unit may be typically used in high flow high pressure applications for example, but not limited to, jet engine, gas turbine, and large industrial processes.

In an embodiment, the processor 202 may be configured to control the set of heat exchanger units 310 to increase the temperature of the first set of reactants before transferring the first of reactants to the reactor unit 308. In an example, the green ammonia 116 may be produced based on a chemical reaction between the hydrogen 112 and the nitrogen 114 at an extremely high pressure (e.g., 140-250 bars) and an extremely high temperature (e.g., around 350 degrees Celsius) in the presence of a suitable catalyst. Therefore, the set of heat exchanger units 310 may require an enormous amount of heat to increase the temperature of the first set of reactants to make it suitable to be fed to the reactor unit 308 for the production of the green ammonia 116 at a first timestamp (say at Time “T1”).

Further, the processor 202 may be configured to control the reactor unit 308 to produce the green ammonia 116 at the first timestamp based on a chemical reaction between the compressed first set of reactants. For example, the first set of reactants may be fed into the reactor unit 308 after increasing the pressure of the first set of reactants to the second pressure value, such that the chemical reaction may be favored to produce green ammonia 116 efficiently. The chemical reaction may be conducted in the presence of the catalyst in the reactor unit 308. In an embodiment, the reactor unit 308 utilizes an iron-based catalyst to facilitate the chemical reaction between the compressed first set of reactants. For example, the reactor unit 308 (also called a green ammonia synthesis reactor) may be typically designed as a fixed-bed reactor, where a solid catalyst, usually an iron-based catalyst, may be used to facilitate the chemical reaction between the set of reactants.

Inside the reactor unit 308, the nitrogen 114 and hydrogen 112 may come in contact with the catalyst that provides a surface for the chemical reaction to occur. The nitrogen 114 and hydrogen 112 may react to produce the green ammonia 116 according to the following reaction:

$${N}_{2} + 3 {H}_{2} \to 2 N {H}_{3} \qquad ( 1 )$$

In the above reaction (1), two atoms of nitrogen and six atoms of hydrogen may react to produce two molecules of green ammonia. The reaction (1) may be an exothermic reaction which means the reaction (1) may generate a significant amount of heat during the chemical reaction. The generated heat may increase the temperature within the reactor unit 308, thereby leading to suboptimal conditions for the chemical reaction or may even damage the catalyst. Therefore, the reactor unit 308 may be designed to allow for the efficient transfer of the heat generated, while the production of the green ammonia 116, from the reactor unit 308 to the set of heat exchanger units 310, thereby maintaining favorable conditions for the chemical reaction (for example, the Haber-Bosch process). This enables heat recovery as well as heat utilization in a process for the production of green ammonia 116, thereby leading to save energy and enhance the production of green ammonia 116.

At a second timestamp (say at Time “T2”) after the first timestamp (T1) when the green ammonia 116 was produced, the processor 202 may be configured to control the set of heat exchanger units 310 to increase a temperature of a second set of reactants from a first temperature value to a second temperature value using heat generated during the production of the green ammonia 116 in the reactor unit 308 at the first timestamp. The second set of reactants may be similar to the first set of reactants and may include the hydrogen 112 and nitrogen 114. In an example, the first temperature value of the second set of reactants may be 85 degrees Celsius and the second temperature value of the second set of reactants may be 150 degrees Celsius. Such an elevation in the temperature value of the second set of reactants may save a lot of energy required to elevate the temperature value of the second set of reactants.

The set of heat exchanger units 310 may be configured to transfer or exchange heat between two fluids and/or gases. Further, the set of heat exchanger units 310 may facilitate efficient transfer of heat or thermal energy from one fluid and/or gas to another, without the fluids and/or gases mixing with each other. In the context of the production of green ammonia 116, the set of heat exchanger units 310 may be configured to utilize the heat generated during the production of the green ammonia 116 in the reactor unit 308 at the first timestamp (T1), to increase the temperature of the second set of reactants to the second temperature before being fed into the reactor unit 308 at the second timestamp (T2). In an example, the second set of reactants may be further heated to reach a temperature (such as the third temperature) that may be favorable to conduct the chemical reaction required for the production of green ammonia 116. By way of example and not limitation, the set of heat exchanger units 310 may receive the second set of reactants at a temperature lower than the first temperature (e.g., hydrogen at 85° C.). Thus, the set of heat exchanger units 310 may utilize the heat generated during the production of the green ammonia 116 to increase the temperature of the second set of reactants from the first temperature value to the second temperature value (for example, 150° C.). This helps in saving energy utilized to heat the second set of reactants to reach the third temperature value from the second temperature value.

In an embodiment, the apparatus 102 may be configured to control the set of heat exchanger unit 310 to increase the temperature of the second set of reactants using lye circulation cooler 320. The lye circulation cooler 320 may correspond to a specialized heat exchanger unit to lower a temperature of lye (for example, but not limited to, a sodium hydroxide solution, or a potassium carbonate solution) circulating within tubes of the lye circulation cooler 320. In operation, a hot lye flows through tubes of the lye circulation cooler 320 transferring its heat to the second set of reactants which flows in a separate channel. The purpose of the lye circulation cooler 320 may focus on maintaining the lye at a specific temperature to ensure optimal reaction conditions safety and efficiency in processes like chemical manufacturing. The lye circulation cooler 320 may help to increase the temperature of the second set of reactants before being fed into the set of heat exchanger units 310. The lye circulation cooler 320 may include a circulation pump which may continuously circulate the lye through a cooler. In operation, the heated lye may flow through the lye circulation cooler 320. Further, the second set of reactants may be passed through the lye circulation cooler 320 where they may come in indirect contact with heated lye. The heated lye may transfer its heat to the second set of reactants, thereby increasing the temperature of the second set of reactants to a fifth temperature value by absorbing the heat from the lye solution. In an example, the second set of reactants may enter the lye circulation cooler 320 at a temperature value that lies between a range of 30-50 degrees Celsius and after effective heat exchange from the lye circulation cooler 320 the temperature of the second set of reactants may be increased to the fifth temperature value that lies between range of 65-90 degrees Celsius.

Thereafter, the processor 202 may be configured to control the set of heat exchanger units 310 to further increase the temperature of the second set of reactants from the fifth temperature value to the second temperature value using heat generated during the production of the green ammonia 116 in the reactor unit 308 at the first timestamp (T1). In this case, less energy may be required to heat the second set of reactants to the second temperature value as the set of reactants may be already at the fifth temperature value (which may be higher than the first temperature value) in the set of heat exchanger units 310. Thus, the use of energy required to heat the second set of reactants may be eradicated to some extent which may ultimately save energy and money. Further, the processor 202 may control the set of heat exchanger unit 310 to further increase the temperature of the second set of reactants to the third temperature value to make it suitable to be fed to the reactor unit 308 after effective heat exchange from the lye circulation cooler 320.

Thereafter, the processor 202 may control the reactor unit 308 to produce the green ammonia 116 at the second timestamp based on the chemical reaction between the second set of reactants. The second sets of reactants may be fed into the reactor unit 308 at the second pressure value and at the third temperature value. The third temperature value may be a temperature that may be favorable to facilitate the chemical reaction between the second set of reactants for efficient production of the green ammonia 116. For example, the third temperature may be 350 degrees Celsius. In an embodiment, the third temperature value may be greater than the second temperature value. For example, the third temperature value may be a value that lies between a range of 330-500 degrees Celsius and second temperature value may be a value that lies between a range of 130-150 degrees Celsius.

Further, the chemical reaction between the second set of reactants may be performed in the presence of the iron-based catalyst. To optimize the series of chemical reactions, the reactor unit 308 may be maintained at specific pressure and temperature range. Further, the heat generated during the production of the green ammonia 116 in the reactor unit 308 at the second timestamp may be sent back to the set of heat exchanger units 310 creating a loop, thereby enhancing efficiency of the green ammonia 116 production process, and conserve energy.

For example, the green ammonia 116 may be produced at the third temperature, a pre-determined amount of heat generated during the produced green ammonia 116 may be utilized by the set of heat exchanger units 310 to heat the second set of reactants, thereby decreasing the temperature of the green ammonia 116 from the third temperature value. Further, the temperature of the produced green ammonia 116 needs to be decreased from the third temperature value to a fourth temperature value to make it suitable for storage in the storage unit 312. Therefore, the produced green ammonia 116 may be fed to a chilling unit 314, after passing through the set of heat exchanger units 310, to cool down for storage in the storage unit 312.

In an embodiment, the processor 202 may be configured to control the chilling unit 314 to decrease the temperature of the produced green ammonia 116 from the third temperature value to the fourth temperature value. The third temperature value may be greater than the fourth temperature value. The chilling unit 314 may be a system design to remove heat from the produced green ammonia 116, thereby lowering its temperature from the third temperature value to the fourth temperature value. In an example, the chilling unit 314 may compress the produced green ammonia 116 received after passing through the set of heat exchanger units 310 to decrease the temperature of the green ammonia 116 for storage or further use. For example, the produced green ammonia 116 may be used in the manufacturing of fertilizers, cleaning agents, and the like.

The chilling unit 314 includes for example, but not limited to, a refrigeration compressor, an evaporator, a condenser, and an expansion valve, working together to circulate a refrigerant through the chilling unit 314. The chilling unit 314 may be used in industrial processes to provide consistent cooling and temperature control. In an embodiment, the temperature of the green ammonia 116 may be decreased by the chilling unit 314 using for example, but not limited to, a refrigeration compressor 314A and a chiller 314B.

The refrigeration compressor 314A compresses the refrigerant, thereby raising its pressure and temperature so it can release the absorbed heat at the condenser. The refrigeration compressor 314A functions by drawing in the low-pressure refrigerant from the evaporator and compressing it into the high pressure, high temperature. This enables the refrigerant to continuously absorb and dissipate heat, thereby maintaining desired temperatures. In an example, the refrigerant absorbs the heat from the green ammonia 116 at the evaporator which may be then dissipated at the chiller 314B. The heat absorbed by the refrigerant in the evaporator may be transferred to refrigeration compressor 314A, where the pressure and temperature of the refrigerant may be increased. The heated refrigerant may then enter the condenser, where the heat of refrigerant may be released. Further, the refrigerant may pass through the expansion valve to reduce pressure and temperature before returning to the evaporator. In an example, the refrigerant may refer to a cooling fluid. In an embodiment, the refrigeration compressor 314A may increase the pressure of a refrigerant, which may be further used to increase the pressure of the refrigerant. The refrigerant may be used in refrigeration cycle to absorb and release heat. The refrigeration compressor 314A may be responsible for compressing low-pressure, low-temperature refrigerant into high pressure and high temperature refrigerant. Further, the refrigeration compressor 314A may use at least one of: a reciprocating compressor unit, and a centrifugal compressor unit.

In an embodiment, the processor 202 may be configured to control the storage unit 312 to store the green ammonia 116 produced at the first timestamp and the second timestamp. In an example, the produced green ammonia 116 may be further stored in large tanks under controlled environment. In an example, the storage unit 312 may be further crafted from materials like steel or fiberglass-reinforced plastic as a defense mechanism from corrosive properties of the green ammonia 116. In an example, the storage unit 312 may include, but is not limited to a tank, a cylinder, and the like.

FIG. 4 is a flowchart that illustrates an exemplary method for production of the green ammonia using heat exchanger unit, in accordance with an embodiment of the present disclosure. FIG. 4 is explained in conjugation with elements of the FIG. 1, FIG. 2 and FIG. 3. With reference to FIG. 4, there is shown a flowchart 400. The operations of the exemplary method may be executed by any computing system, for example, by the apparatus 102 of FIG. 1 or the processor 202 of FIG. 2. The operation of the flowchart 400 may start at 402.

At 402, the compressor unit 104 may be controlled to compress the first set of reactants to increase pressure of the first set of reactants from the first pressure value to the second pressure value. In an embodiment, the processor 202 may be configured to control the compressor unit 104 to compress the first set of reactants to increase pressure of the first set of reactants from the first pressure value to the second pressure value. Details associated with compressor unit 104 are provided in FIG. 1, and FIG. 3.

At 404, the reactor unit 106 may be controlled to produce the green ammonia 116 at the first timestamp (T1) based on the chemical reaction between the compressed first set of reactants. In an embodiment, the processor 202 may be configured to control the reactor unit 106 to produce the green ammonia 116 at the first timestamp (T1) based on the chemical reaction between the compressed first set of reactants. Details associated with reactor unit 106 are provided in FIG. 1, and FIG. 3.

At 406, the set of heat exchanger units 108 may be controlled to increase temperature of the second set of reactants from the first temperature value to the second temperature value using heat generated during the production of green ammonia 116 in the reactor unit 106. In an embodiment, the processor 202 may be configured to control the set of heat exchanger units 108 to increase temperature of the second set of reactants from the first temperature value to the second temperature value using heat generated during the production of green ammonia 116 in the reactor unit 106. Details associated with set of heat exchanger units 108 are provided in FIG. 1, and FIG. 3.

At 408, the reactor unit 106 may be controlled to produce the green ammonia 116 at the second timestamp (T2) based on the chemical reaction between the second set of reactants. In an embodiment, the processor 202 may be configured to control the reactor unit 106 to produce the green ammonia 116 at the second timestamp (T2) based on the chemical reaction between the second set of reactants. The second set of reactants may be fed into the reactor unit 106 at the second pressure value and at the third temperature value.

At 410, the storage unit 110 may be controlled to store the green ammonia 116 produced at the first timestamp (T1) and the second timestamp (T2). In an embodiment, the processor 202 may be configured to control the storage unit 110 to store the green ammonia 116 produced at the first timestamp (T1) and the second timestamp (T2). Control may pass to end.

Accordingly, blocks of the flowchart 400 support combinations of means for performing the specified functions and combinations of operations for performing the specified functions. It will also be understood that one or more blocks of the flowchart 400, and combinations of blocks in the flowchart 400, can be implemented by special-purpose hardware-based computer systems which perform the specified functions, or combinations of special-purpose hardware and computer instructions.

Alternatively, the apparatus 102 may include means for performing each of the operations described above. In this regard, according to an example embodiment, examples of means for performing operations may comprise, for example, the processor and/or a device or circuit for executing instructions or executing an algorithm for processing information as described above.

Various embodiments of the disclosure may provide a non-transitory computer readable medium having stored thereon computer executable instructions, which when executed by one or more processors (such as the processor 202), cause the one or more processors to carry out operations to operate an apparatus (e.g., the apparatus 102) for production of green ammonia. The instructions may cause the machine and/or computer to perform operations including, controlling the compressor unit 104 to compress the first set of reactants to increase the pressure of the first set of reactants from the first pressure value to the second pressure value. The operations may further include controlling the reactor unit 106 to produce green ammonia 116 at the first timestamp (T1) based on the chemical reaction between the compressed first set of reactants. The operations may further include controlling the set of heat exchanger units 108 to increase the temperature of the second set of reactants from the first temperature value to the second temperature value using heat generated during the production of the green ammonia 116 in the reactor unit 106. The operations may further include controlling the reactor unit 106 to produce the green ammonia 116 at a second timestamp (T2) based on the chemical reaction between the second set of reactants. The second sets of reactants are fed into the reactor unit 106 at the second pressure value and at the third temperature value. Further, the operations may include controlling the storage unit 110 to store the green ammonia 116 produced at the first timestamp (T1) and the second timestamp (T2).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed:

1. An apparatus, comprising:
at least one non-transitory memory configured to store computer-executable instructions; and
at least one processor configured to execute the computer-executable instructions to:
control a compressor unit to compress a first set of reactants to increase a pressure of the first set of reactants from a first pressure value to a second pressure value;
control a reactor unit to produce green ammonia at a first timestamp based on a chemical reaction between the compressed first set of reactants;
control a set of heat exchanger units to increase a temperature of a second set of reactants from a first temperature value to a second temperature value using heat generated during the production of the green ammonia in the reactor unit at the first timestamp;
control the reactor unit to produce the green ammonia at a second timestamp based on the chemical reaction between the second set of reactants, wherein the second set of reactants are fed into the reactor unit at the second pressure value and at a third temperature value; and
control a storage unit to store the green ammonia produced at the first timestamp and the second timestamp.

2. The apparatus of claim 1, wherein the first set of reactants and the second set of reactants comprises of hydrogen and nitrogen.

3. The apparatus of claim 1, wherein the third temperature value is greater than the second temperature value.

4. The apparatus of claim 1, wherein the third temperature value is same as the second temperature value.

5. The apparatus of claim 1, further comprising a hydrogen generation unit, and wherein the processor is further configured to control the hydrogen generation unit to produce hydrogen by electrolyzing water, and wherein the first set of reactants and the second set of reactants comprises the produced hydrogen.

6. The apparatus of claim 5, further comprising a hydrogen storage unit, and wherein the processor is further configured to control the hydrogen storage unit to store the produced hydrogen.

7. The apparatus of claim 1, further comprising an air separation unit, and wherein the processor is further configured to control the air separation unit to produce nitrogen, and wherein the first set of reactants and the second set of reactants comprises the produced nitrogen.

8. The apparatus of claim 1, wherein the first temperature value is 85 degrees Celsius, the second temperature value is 150 degrees Celsius, and the third temperature value lies between a range of 330 degrees Celsius to 500 degrees Celsius.

9. The apparatus of claim 1, wherein the second pressure value lies between a range of 140 bars to 250 bars, and the first pressure value is less than the second pressure value.

10. The apparatus of claim 1, wherein the first set of reactants are compressed by the compressor unit using at least one of: a reciprocating compressor unit, a centrifugal compressor unit, or an axial flow compressor unit.

11. The apparatus of claim 1, wherein the reactor unit utilizes an iron-based catalyst to facilitate at least one of: the chemical reaction between the compressed first set of reactants, and the chemical reaction between the second set of reactants.

12. The apparatus of claim 1, further comprising a chilling unit, and wherein the processor is further configured to:
control the chilling unit to decrease a temperature of the green ammonia produced at the first timestamp and the second timestamp from the third temperature value to a fourth temperature value, wherein the third temperature value is greater than the fourth temperature value.

13. The apparatus of claim 12, wherein the temperature of the green ammonia produced at the first timestamp and the second timestamp is decreased by the chilling unit using at least one of: a chiller and refrigeration compressor.

14. The apparatus of claim 12, wherein the processor is further configured to control the chilling unit using to compress the green ammonia produced at the first timestamp and the second timestamp to make the produced green ammonia stable for storage in the storage unit.

15. A method, comprising:
controlling a compressor unit to compress a first set of reactants to increase a pressure of the first set of reactants from a first pressure value to a second pressure value;
controlling a reactor unit to produce green ammonia at a first timestamp based on a chemical reaction between the compressed first set of reactants;
controlling a set of heat exchanger units to increase a temperature of a second set of reactants from a first temperature value to a second temperature value using heat generated during the production of the green ammonia in the reactor unit at the first timestamp;
controlling the reactor unit to produce the green ammonia at a second timestamp based on the chemical reaction between the second set of reactants, wherein the second set of reactants are fed into the reactor unit at the second pressure value and at a third temperature value; and
controlling a storage unit to store the green ammonia produced at the first timestamp and the second timestamp.

16. The method of claim 15, wherein the first set of reactants and the second set of reactants comprises of hydrogen and nitrogen.

17. The method of claim 16, further comprising controlling a hydrogen generation unit to produce hydrogen by electrolyzing water, and wherein the first set of reactants and the second set of reactants comprises the produced hydrogen.

18. The method of claim 17, further comprising controlling a hydrogen storage unit to store the produced hydrogen.

19. The method of claim 15, further comprising controlling an air separation unit to produce nitrogen, and wherein the first set of reactants and the second set of reactants comprises the produced nitrogen.

20. A non-transitory computer-readable medium having stored thereon, computer-executable instructions that when executed by a processor of a system, causes the processor to execute operations, the operations comprising:
controlling a compressor unit to compress a first set of reactants to increase a pressure of the first set of reactants from a first pressure value to a second pressure value;
controlling a reactor unit to produce green ammonia at a first timestamp based on a chemical reaction between the compressed first set of reactants;
controlling a set of heat exchanger units to increase a temperature of a second set of reactants from a first temperature value to a second temperature value using heat generated during the production of the green ammonia in the reactor unit at the first timestamp;
controlling the reactor unit to produce the green ammonia at a second timestamp based on the chemical reaction between the second set of reactants, wherein the second set of reactants are fed into the reactor unit at the second pressure value and at a third temperature value; and
controlling a storage unit to store the green ammonia produced at the first timestamp and the second timestamp.
